(19) United States
(12) Patent Application Publication
(10) Pub. No.: US 2005/0072410 A1
(43) Pub. Date: Apr. 7, 2005

(54) Air-fuel ratio feedback control apparatus and method for internal combustion engine

(75) Inventor: Masanobu Ohsaki, Atsugi-shi (JP)

Correspondence Address: FOLEY AND LARDNER;SUITE 500, 3000 K STREET NW, WASHINGTON, DC, 20007, US

(73) Assignee: HITACHI UNISIA AUTOMOTIVE, LTD.

(21) Appl. No.: 10/739,033

(22) Filed: Dec. 19, 2003

(30) Foreign Application Priority Data
Dec. 25, 2002 (JP) 2002-374855

(51) Int. Cl. F02D 41/14

(52) U.S. Cl. 123/674

(57) ABSTRACT

In the diagnosing process in which a target air-fuel ratio in an air-fuel ratio feedback control is forcibly changed, and based on a response time of detection signal from an air-fuel ratio sensor to the change, a response characteristic of the air-fuel ratio sensor is diagnosed, when the diagnosis is finished, an air-fuel ratio feedback control signal is returned in stepwise to a value in just before the starting of diagnosis.

### FIELD OF THE INVENTION

The present invention relates to a technique for diagnosing a response characteristic of an air-fuel ratio sensor, while feedback controlling an air-fuel ratio based on a detection result of the air-fuel ratio sensor.

### RELATED ART

Japanese Unexamined Patent Publication No. 11-264340 discloses a constitution in which a target air-fuel ratio is forcibly changed during an air-fuel ratio feedback control, and based on a change in output of an air-fuel ratio sensor to the change in the target air-fuel ratio, response deterioration of the air-fuel ratio sensor is diagnosed.

In the conventional diagnosis process as described above, since the target air-fuel ratio is forcibly changed and further, a feedback gain is increased during the diagnosis, the target air-fuel ratio may be greatly deviated from a primary target air-fuel ratio at the time when the diagnosis is finished.

However, when the diagnosis is finished, the feedback gain is returned to a normal feedback gain and therefore, it takes time to return the target air-fuel ratio to the primary target air-fuel, ratio, resulting in the deterioration in exhaust performance during this time.

Here, if the feedback gain is maintained high even just after the diagnosis is finished, although the target air-fuel ratio can be returned rapidly up to the vicinity of the primary target air-fuel ratio, there is caused a problem of overshoot of air-fuel ratio.

### SUMMARY OF THE INVENTION

The present invention has been accomplished in view of the above problem, and has an object of avoiding deterioration of exhaust performance just after diagnosis is finished, in a diagnosis control performed by forcibly changing a target air-fuel ratio in an air-fuel ratio feedback control.

In order to achieve the above object, the present invention is constituted so that a value of an air-fuel ratio feedback control signal in just before starting the diagnosis is stored, and at the time when the diagnosis is finished, the air-fuel ratio feedback control signal is reset to the stored value.

The other objects and features of this invention will become understood from the following description with reference to the accompanying drawings.

### BRIEF EXPLANATION OF THE DRAWINGS

FIG. 1 is a diagram showing a system configuration of an internal combustion engine in an embodiment.

FIG. 2 is a flowchart showing the diagnosing process of an air-fuel ratio sensor in the embodiment.

FIG. 3 is a time chart showing a change in detection signal from the air-fuel ratio sensor with the switching of target air-fuel ratio in the embodiment.

FIG. 4 is a structural diagram of the air-fuel ratio sensor in the embodiment.

FIG. 5 is a diagram showing the detection theory of the air-fuel ratio sensor in the embodiment.

### PREFERRED EMBODIMENT

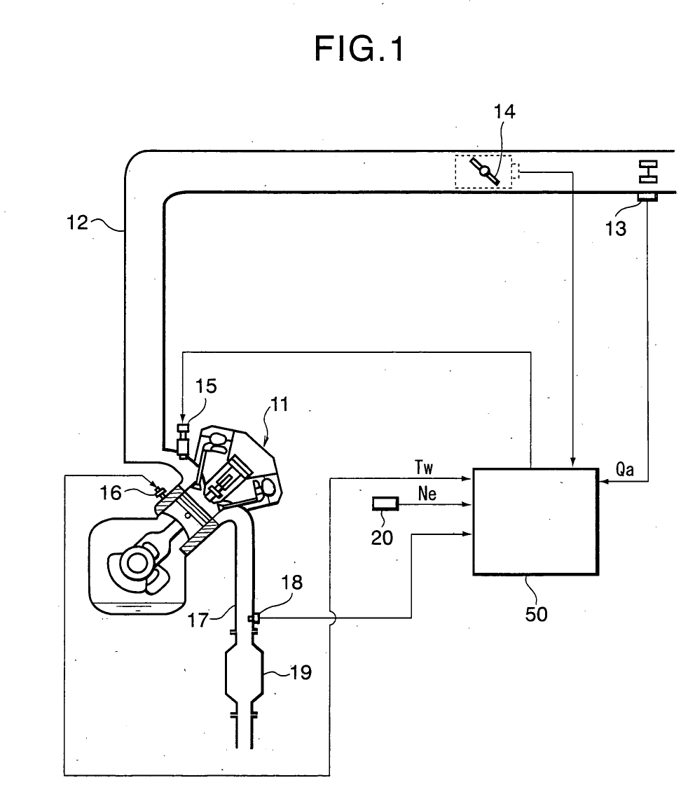

In FIG. 1, in an intake pipe 12 of an internal combustion engine 11, an air flow meter 13 detecting an intake air flow amount Qa and an intake choke valve 14 linked to an accelerator pedal to control the intake air flow amount Qa are disposed.

In a manifold portion downstream of intake choke valve 14, an electromagnetic type fuel injection valve 15 is disposed for each cylinder.

Fuel injection valve 15 is opened by a drive pulse signal output from a control unit 50, to inject fuel adjusted to a predetermined pressure.

Further, there is provided a water temperature sensor 16 detecting a cooling water temperature Tw in a cooling jacket of engine 11.

On the other hand, an air-fuel ratio sensor 18 detecting an air-fuel ratio of combusted mixture based on an oxygen concentration in the exhaust gas is disposed in the vicinity of the junction of exhaust pipe 17.

In exhaust pipe 17, a three-way catalyst 19 is disposed on the downstream side of air-fuel ratio sensor 18.

Three-way catalyst 19 has a function for oxidizing CO and HC, and reducing NOx simultaneously, with high efficiency, when the air-fuel ratio is in the vicinity of a stoichiometric air-fuel ratio, to purity the exhaust gas.

Here, the structure of air-fuel ratio sensor 18 and the theory of detecting the air-fuel ratio will be described.

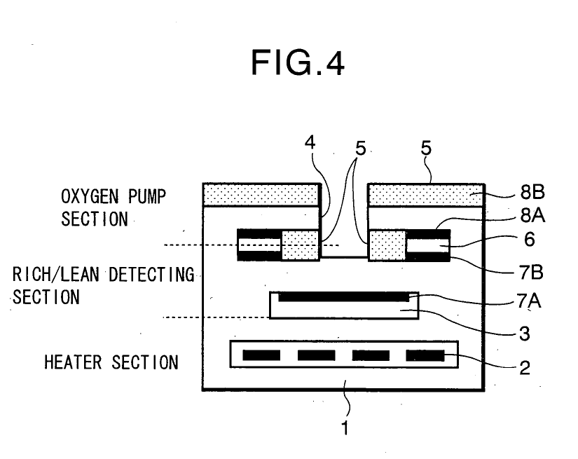

FIG. 4 shows the structure of air-fuel ratio sensor 18.

A body 1 of air-fuel ratio sensor 18 is formed of zirconia Zr₂O₃ having, for example, the oxygen ion conductivity, and is disposed with a heater 2.

Further, body 1 is disposed with an atmosphere inlet 3 communicating with the atmosphere and also a gas diffusion layer 6 to which the engine exhaust gas is introduced via a gas inlet 4 and a protective layer 5.

Moreover, a sensing electrode 7A is disposed on an atmosphere inlet 3 side and a sensing electrode 7B is disposed on a gas diffusion layer 6 side. Sensing electrode 7A and sensing electrode 7B face each other with zirconia Zr₂O₃ therebetween.

Furthermore, a pump electrode 8A is disposed on the gas diffusion layer 6 side, and a pump electrode 8B facing pump electrode 8A is disposed on a peripheral side of body 1.

Here, a voltage according to a ratio between an oxygen concentration (oxygen partial pressure) in gas diffusion layer 6 and an oxygen ion concentration in the atmosphere, is generated between sensing electrodes 7A and 7B.

Accordingly, it is detected based on the voltage whether the air-fuel ratio in gas diffusion layer 6 is richer or leaner than the stoichiometric air-fuel ratio.

On the other hand, a voltage is applied between pump electrodes 8A and 8B, according to the voltage generated between sensing electrodes 7A and 7B, namely, according to the rich or lean of the air-fuel ratio in gas diffusion layer 6.

If a predetermined voltage is applied between pump electrodes 8A and 8B, according to this, oxygen ions in gas diffusion layer 6 are migrated, and a current flows between pump electrodes 8A and 8B.

Here, when the predetermined voltage is applied between pump electrodes 8A and 8B, a current value (limiting current) Ip flowing between pump electrodes 8A and 8B is influenced by an oxygen ion concentration in the exhaust gas, and therefore, it is possible to detect the air-fuel ratio by detecting the current value (limiting current) Ip.

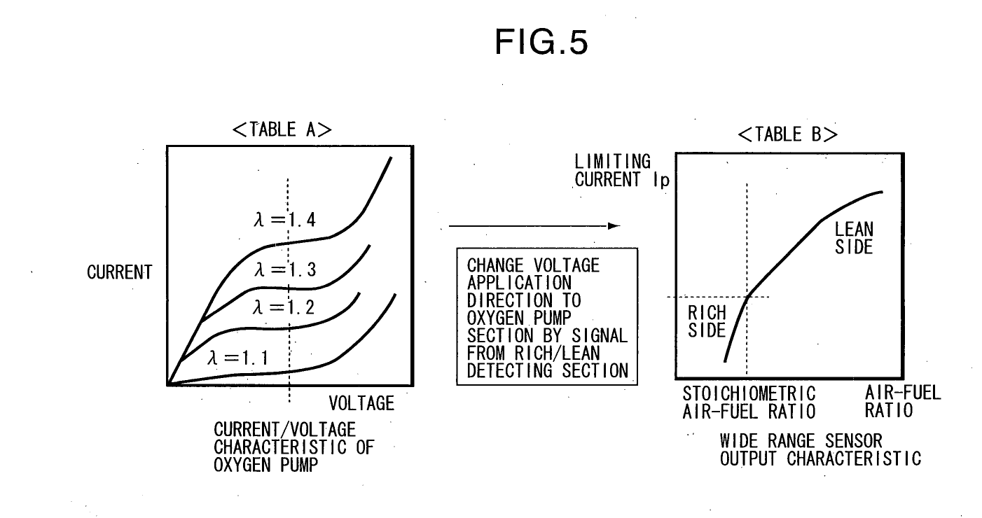

Namely, as shown in table (A) of FIG. 5, there is a fixed correlation between the voltage/current between pump electrodes, and the air-fuel ratio.

Accordingly, an application direction of voltage between pump electrodes 8A and 8B is inverted based on the rich/lean output from sensing electrodes 7A and 7B, so that the air-fuel ratio can be detected in both of lean air-fuel ratio region and rich air-fuel ratio region based on the current value (limiting current) Ip flowing between pump electrodes 8A and 8B.

According to the detection theory described above, by referring to a table (B) of FIG. 5 based on the current value Ip flowing between pump electrodes 8A and 8B, it is possible to detect the air-fuel ratio over a wide range.

Here, the description returns FIG. 1.

Engine 11 is provided with a crank angle sensor 20 detecting an angle of crankshaft. Control unit 50 calculates an engine rotation speed Ne based on a detection signal from crank angle sensor 20.

Control unit 50 incorporates therein a microcomputer comprising CPU, ROM, RAM, A/D converter, input/output interface and the like.

Control unit 50 receives detection signals from air-fuel ratio sensor 18, air flow meter 13, water temperature sensor 16, crank angle sensor 20 and the like, to control a fuel injection quantity of fuel injection valve 15 in the following manner.

Control unit 50 calculates a basic fuel injection pulse width Tp based on the intake air flow amount Qa detected by air flow meter 13 and the engine rotation speed Ne obtained by the detection signal from crank angle sensor 20.
Tp=k×Qa/Ne (k: constant)

Further, control unit 50 calculates a correction coefficient Kw for increasingly correcting the fuel at the low temperature time, a correction coefficient Kas for increasingly correcting the fuel at and after the starting of engine operation, an air-fuel ratio feedback correction coefficient (air-fuel ratio feedback control signal) LAMBDA, a correction portion Ts depending on a battery voltage, and a target equivalence ratio Z corresponding to a target air-fuel ratio.

Then, control unit 50 calculates a final fuel injection pulse width Ti in the following manner.
Ti=Tp×(1+Kw+Kas+ . . . )×LAMBDA×Z+Ts

A drive pulse signal of fuel injection pulse width Ti is sent to fuel injection valve 15, so that the fuel in an amount proportional to an effective injection pulse width Te obtained by subtracting the correction portion Ts from the fuel injection pulse width Ti, is injected.

The air-fuel ratio feedback correction coefficient LAMBDA is the air-fuel ratio feedback control signal for bringing an actual air-fuel ratio detected by air-fuel ratio sensor 18 into the target air-fuel ratio.

The air-fuel ratio feedback correction coefficient LAMBDA is set by a proportional integral and derivative control based on a deviation between the actual air-fuel ratio detected by air-fuel ratio sensor 18 and the target air-fuel ratio.

Note, in an air-fuel ratio feedback control using air-fuel ratio sensor 18, since the air-fuel ratio is stabled in the vicinity of the target air-fuel ratio, the adsorption or desorption of oxygen molecules to or from the catalyst surface is not performed sufficiently. As a result, transformation efficiency in the catalyst may be reduced.

Therefore, in the air-fuel ratio feedback control using air-fuel ratio sensor 18, the adsorption or desorption of oxygen molecules to or from the catalyst surface may be promoted by slightly shifting the target air-fuel ratio around a requested air-fuel ratio.

Further, control unit 50 has a function for diagnosing a response characteristic of air-fuel ratio sensor 18. The following is a description of diagnosis process of the response characteristic.

In the diagnosis process of air-fuel ratio sensor 18, when the air-fuel ratio feedback control is being performed, the target air-fuel ratio is forcibly changed, to diagnose the reduction of response characteristic of air-fuel ratio sensor 18 based on a change in detection signal from air-fuel ratio sensor 18 to the change in the target air-fuel ratio.

To be specific, the reduction of response characteristic of air-fuel ratio sensor 18 is diagnosed depending on a required time until a detection value of air-fuel ratio sensor 18 converges in the target air-fuel ratio after the target air-fuel ratio is changed or a required time until the detection value of air-fuel ratio sensor 18 passes over the target air-fuel ratio (or a predetermined air-fuel ratio) after the target air-fuel ratio is changed.

Further, it is also possible to diagnose response deterioration of air-fuel ratio sensor 18 by measuring a change speed of detection signal from air-fuel ratio sensor 18 after the target air-fuel ratio is changed.

Note, during the diagnosis of air-fuel ratio sensor 18, a value of feedback gain is made larger than that in the normal air-fuel ratio feedback control time, so that timewise variations until the output of air-fuel ratio sensor 18 converges in the post-switched target air-fuel ratio are reduced as few as possible, to improve diagnosis accuracy.

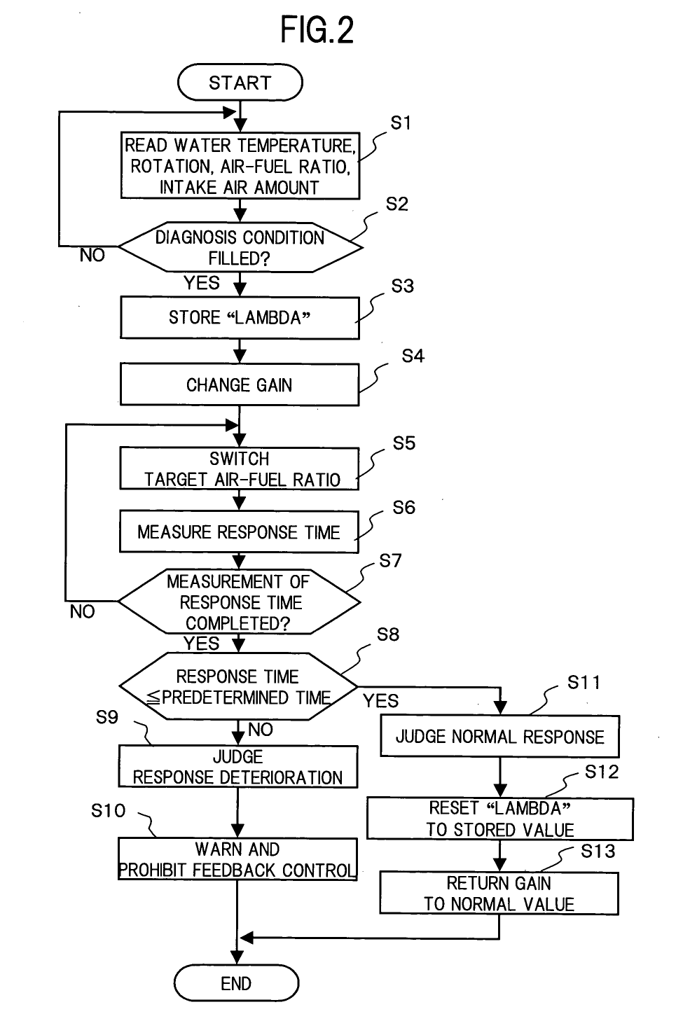

The diagnosis process of air-fuel ratio sensor 18 performed by control unit 50 will be described in detail in accordance with a flowchart shown in FIG. 2.

In step S1, the engine cooling water temperature Tw, the engine rotation speed Ne, an output VAF of air-fuel ratio sensor 18, and the intake air flow amount Qa are read.

In step S2, it is judged whether or not a diagnosis permission condition is filled.

As diagnosis permission conditions, for example, the following four conditions are judged.

(1) A predetermined time has elapsed after the starting of engine operation.

(2) Air-fuel ratio sensor 18 is activated.

(3) The air-fuel ratio is being feedback controlled.

(4) Catalyst 19 is activated.

If the above four conditions (1) through (4) are filled, control proceeds to step S3, where the air-fuel ratio feedback correction coefficient LAMBDA at the time, that is, the air-fuel ratio feedback control signal in just before the starting of diagnosis, is stored.

In step S4, the value of the feedback gain (proportional gain, integral gain and derivative gain) used for the diagnosis is switched to be larger than a normal value.

Note, it is unnecessary to make all of the proportional gain, integral gain and derivative gain larger, and at least one of the three constants may be made larger.

In step S5, the target air-fuel ratio is periodically changed in stepwise.

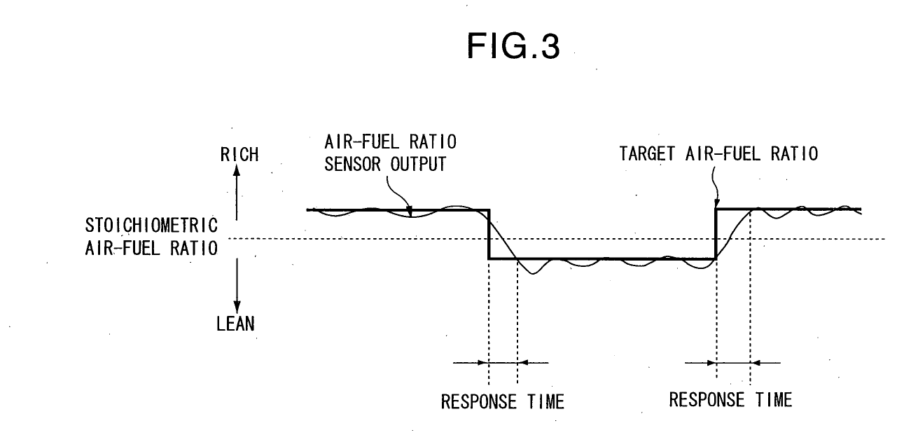

In step S6, a response time of output value of air-fuel ratio sensor 18 at the time when the target air-fuel ratio is inverted from rich to lean, is measured, and further, the response time of output value of air-fuel ratio sensor 18 at the time when the target air-fuel ratio is inverted from lean to rich, is measured (refer to FIG. 3).

The response time is a required time until the detection value of air-fuel ratio sensor 18 converges in the post-switched target air-fuel ratio after the target air-fuel ratio is changed in stepwise, or a required time until the detection value of air-fuel ratio sensor 18 passes over the target air-fuel ratio (or the predetermined air-fuel ratio) after the target air-fuel ratio is changed in stepwise.

In step S7, it is judged whether or not the measurement of response time is completed, and if the measurement is completed, control proceeds to step S8.

In step S8, the judgment of response time is performed.

For example, it is judged whether or not the time until the detection value of air-fuel ratio sensor 18 passes over the target air-fuel ratio from the target air-fuel ratio is inverted from lean to rich (refer to FIG. 3) or the time until the detection value of air-fuel ratio sensor 18 passes over the target air-fuel ratio from the target air-fuel ratio is inverted from rich to lean, is equal to or less than the predetermined time.

Then, if the response time exceeds the predetermined time, control proceeds to step S9, where it is judged that the response characteristic of air-fuel ratio sensor 18 is deteriorated.

When it is judged in step S9 that the response characteristic of air-fuel ratio sensor 18 is deteriorated, in next step S10, an abnormality of air-fuel ratio sensor 18 is notified to a driver by turning a warning signal light on and the like, to urge the driver to perform the repair and the like, and also the air-fuel ratio feedback control based on the detection result of air-fuel ratio sensor 18 is prohibited.

On the other hand, if the response time is equal to or less than the predetermined time, then control proceeds to step S11, where it is judged that the response characteristic of air-fuel ratio sensor 18 is normal.

When it is judged in step S11 that the response characteristic of air-fuel ratio sensor 18 is normal, in next step S12, the air-fuel ratio feedback correction coefficient LAMBDA is reset to the value in just before the starting of diagnosis stored in step S3.

In next step S13, the air-fuel ratio feedback gain and the target air-fuel ratio are returned to the normal values, to resume the normal air-fuel ratio feedback control.

As described in the above, at the time when the diagnosis is finished, if the air-fuel ratio feedback correction coefficient LAMBDA is reset to the value in just before the starting of diagnosis, it is possible to control the air-fuel ratio to be substantially in the vicinity of the target air-fuel ratio in just after the finish of diagnosis. As a result, it is possible to converge rapidly the air-fuel ratio in the target air-fuel ratio without the overshoot, to avoid the deterioration of exhaust performance.

For example, if the normal air-fuel ratio feedback control is resumed without resetting the air-fuel ratio feedback correction coefficient LAMBDA from that at the finish of diagnosis, the exhaust performance is deteriorated during the air-fuel ratio is changed to a primary target air-fuel ratio.

However, the value of air-fuel ratio feedback correction coefficient LAMBDA in just before the starting of diagnosis is estimated to be a value capable of controlling the air-fuel ratio to be in the vicinity of the target air-fuel ratio. Therefore, if the air-fuel ratio feedback correction coefficient LAMBDA is changed in stepwise to such a value, the air-fuel ratio can be converged rapidly in the vicinity of the target air-fuel ratio, to thereby avoid the deterioration of exhaust performance.

The entire contents of Japanese Patent Applications No. 2002-374855 filed Dec. 25, 2002, a priority of which is claimed, are incorporated herein by reference.

While only selected embodiment has been chosen to illustrate the present invention, it will be apparent to those skilled in the art from this disclosure that various changes and modifications can be made herein without departing from the scope of the invention as defined in the appended claims.

Furthermore, the foregoing description of the embodiment according to the present invention is provided for illustration only, and not for the purpose of limiting the invention as defined in the appended claims and their equivalents.

1. An air-fuel ratio feedback control apparatus for an internal combustion engine, comprising:
an air-fuel ratio sensor disposed in an exhaust pipe of said engine, to output a detection signal of an air-fuel ratio;
a control section that receives the detection signal from said air-fuel ratio sensor, and outputs an air-fuel ratio feedback control signal so that the air-fuel ratio detected based on the detection signal is brought into a target air-fuel ratio;
a diagnosing section that forcibly changes said target air-fuel ratio during an air-fuel ratio feedback control by said control section, and diagnoses a response characteristic of said air-fuel ratio sensor based on a change in detection signal from said air-fuel ratio sensor to the change in said target air-fuel ratio, to output a signal indicating a diagnosis result; and
a reset section that stores a value of air-fuel ratio feedback control signal in just before the starting of diagnosis by said diagnosis section, and resets said air-fuel ratio feedback control signal to said stored value when the diagnosis is finished.

2. An air-fuel ratio feedback control apparatus for an internal combustion engine according to claim 1, further comprising;
a gain setting section that changes a value of a feedback gain in said control section to be larger than a normal value when the diagnosis is performed by said diagnosis section.

3. An air-fuel ratio feedback control apparatus for an internal combustion engine according to claim 1,
wherein said diagnosis section diagnoses the response characteristic of said air-fuel ratio sensor based on a time until the detection signal from said air-fuel ratio sensor indicates a predetermined change in air-fuel ratio after said target air-fuel ratio is forcibly changed.

4. An air-fuel ratio feedback control apparatus for an internal combustion engine according to claim 1,
wherein said diagnosis section diagnoses the response characteristic of said air-fuel ratio sensor based on a time of after said target air-fuel ratio is forcibly changed until the detection signal from said air-fuel ratio sensor converges in a value equivalent to the post-changed target air-fuel ratio.

5. An air-fuel ratio feedback control apparatus for an internal combustion engine according to claim 1,
wherein said diagnosis section diagnoses the response characteristic of said air-fuel ratio sensor based on a time until the detection signal from said air-fuel ratio sensor passes over a value equivalent to a predetermined air-fuel ratio after said target air-fuel ratio is forcibly changed.

6. An air-fuel ratio feedback control apparatus for an internal combustion engine according to claim 1,
wherein said diagnosis section diagnoses the response characteristic of said air-fuel ratio sensor based on a change speed in detection signal from said air-fuel ratio sensor after said target air-fuel ratio is forcibly changed.

7. An air-fuel ratio feedback control apparatus for an internal combustion engine according to claim 1, further comprising;
an exhaust purification catalyst disposed downstream of said air-fuel ratio sensor in said exhaust pipe;
wherein said diagnosis section diagnoses the response characteristic of said air-fuel ratio sensor, provided that a predetermined time or above has elapsed from the starting of engine operation, and said air-fuel ratio sensor is activated, and said exhaust purification catalyst is activated.

8. An air-fuel ratio feedback control apparatus for an internal combustion engine according to claim 1,
wherein said air-fuel ratio sensor includes:
a gas diffusion layer to which the engine exhaust gas is introduced;
a rich/lean detecting section that detects whether an air-fuel ratio in said gas diffusion layer is richer or leaner than a stoichiometric air-fuel ratio; and
a pump section that is applied with a voltage based on the detection result of said rich/lean detecting section, to migrate oxygen ions in gas diffusion layer 6.

9. An air-fuel ratio feedback control apparatus for an internal combustion engine according to claim 1, further comprising;
a feedback control prohibition section that prohibits the air-fuel ratio feedback control by said control section, when a signal indicating response deterioration is output from said diagnosis section.

10. An air-fuel ratio feedback control apparatus for an internal combustion engine according to claim 1,
wherein said diagnosis section periodically changes said target air-fuel ratio in stepwise.

11. An air-fuel ratio feedback control apparatus for an internal combustion engine, comprising:
air-fuel ratio detecting means disposed in an exhaust pipe of said engine, for outputting a detection signal of an air-fuel ratio;
control means for receiving the detection signal from said air-fuel ratio detecting means, and outputting an air-fuel ratio feedback control signal so that the air-fuel ratio detected based on the detection signal is brought into a target air-fuel ratio;
diagnosing means for forcibly changing said target air-fuel ratio during an air-fuel ratio feedback control by said control means, and diagnosing a response characteristic of said air-fuel ratio detecting means based on a change in detection signal from said air-fuel ratio detecting means to the change in said target air-fuel ratio, to output a signal indicating a diagnosis result; and
reset means for storing a value of air-fuel ratio feedback control signal in just before the starting of diagnosis by said diagnosis means, and resetting said air-fuel ratio feedback control signal to said stored value when the diagnosis is finished.

12. An air-fuel ratio feedback control method for an internal combustion engine, comprising the steps of:
detecting an air-fuel ratio based on a detection signal from an air-fuel ratio sensor disposed in an exhaust pipe of said engine;
outputting an air-fuel ratio feedback control signal so that the air-fuel ratio detected based on the detection signal is brought into a target air-fuel ratio;
forcibly changing said target air-fuel ratio during an air-fuel ratio feedback control, to diagnose a response characteristic of said air-fuel ratio sensor based on a change in detection signal to the change in said target air-fuel ratio;
storing a value of air-fuel ratio feedback control signal in just before the starting of diagnosis; and
resetting said air-fuel ratio feedback control signal to said stored value when the diagnosis is finished.

13. An air-fuel ratio feedback control method for an internal combustion engine according to claim 12, further comprising the step of;
changing a value of a feedback gain to be larger than a normal value when the response characteristic of said air-fuel ratio sensor is diagnosed.

14. An air-fuel ratio feedback control method for an internal combustion engine according to claim 12,
wherein said step of diagnosing the response characteristic of said air-fuel ratio sensor comprises the steps of
measuring a time until the detection signal from said air-fuel ratio sensor indicates a predetermined change in air-fuel ratio after said target air-fuel ratio is forcibly changed;
comparing said measured time with a predetermined time; and
outputting a signal indicating response deterioration when said measured time exceeds the predetermined time.

15. An air-fuel ratio feedback control method for an internal combustion engine according to claim 12,
wherein said step of diagnosing the response characteristic of said air-fuel ratio sensor comprises the steps of:
measuring a time of after said target air-fuel ratio is forcibly changed until the detection signal from said air-fuel ratio sensor converges in a value equivalent to the post-changed target air-fuel ratio;
comparing said measured time with a predetermined time; and
outputting a signal indicating response deterioration when said measured time exceeds the predetermined time.

16. An air-fuel ratio feedback control method for an internal combustion engine according to claim 12,
wherein said step of diagnosing the response characteristic of said air-fuel ratio sensor comprises the steps of:
measuring a time until the detection signal from said air-fuel ratio sensor passes over a value equivalent to a predetermined air-fuel ratio after said target air-fuel ratio is forcibly changed;
comparing said measured time with a predetermined time; and
outputting a signal indicating response deterioration when said measured time exceeds the predetermined time.

17. An air-fuel ratio feedback control method for an internal combustion engine according to claim 12,
wherein said step of diagnosing the response characteristic of said air-fuel ratio sensor comprises the steps of:
measuring a change speed in detection signal from said air-fuel ratio sensor after said target air-fuel ratio is forcibly changed;
comparing said measured change speed with a predetermined speed; and
outputting a signal indicating response deterioration when said measured change speed is below said predetermined speed.

18. An air-fuel ratio feedback control method for an internal combustion engine according to claim 12,
wherein an exhaust purification catalyst is disposed downstream of said air-fuel ratio sensor in said exhaust pipe, and
said step of diagnosing the response characteristic of said air-fuel ratio sensor comprises the steps of:
judging whether or not a predetermined time or above has elapsed from the starting of engine operation;
judging whether or not said air-fuel ratio sensor is activated;
judging whether or not said exhaust purification catalyst is activated; and
outputting a diagnosis permission signal when the predetermined time or above has elapsed from the starting of engine operation, and said air-fuel ratio sensor is activated, and said exhaust purification catalyst is activated.

19. An air-fuel ratio feedback control method for an internal combustion engine according to claim 12, further comprising the step of;
prohibiting the air-fuel ratio feedback control, when response deterioration of said air-fuel ratio sensor is diagnosed.

20. An air-fuel ratio feedback control method for an internal combustion engine according to claim 12,
wherein said step of diagnosing the response characteristic of said air-fuel ratio sensor comprises the steps of:
periodically changing said target air-fuel ratio in stepwise during the air-fuel ratio feedback control;
measuring a response time of said detection signal at a time when said target air-fuel ratio is changed in stepwise to a richer side and at a time when said target air-fuel ratio is changed in stepwise to a leaner side;
comparing said response time with a predetermined time; and
outputting a signal indicating response deterioration when said response time exceeds the predetermined time.
